(19) United States
(12) Patent Application Publication
(10) Pub. No.: US 2016/0218376 A1
(43) Pub. Date: Jul. 28, 2016

(54) BIPOLAR PLATE AND FUEL CELL MODULE USING THE SAME

(71) Applicant: INDUSTRIAL TECHNOLOGY RESEARCH INSTITUTE, Hsinchu (TW)

(72) Inventors: Cheng-Hong LIU, Chiayi City (TW); Cheng-Hao YANG, Tainan City (TW); Ching-Ying HUANG, Kaohsiung City (TW); Wen-Lin WANG, Kaohsiung City (TW)

(73) Assignee: INDUSTRIAL TECHNOLOGY RESEARCH INSTITUTE, Hsinchu (TW)

(21) Appl. No.: 14/939,741

(22) Filed: Nov. 12, 2015

(30) Foreign Application Priority Data
Jan. 26, 2015 (TW) 104102505

(51) Int. Cl. H01M 8/02; H01M 8/04

(52) U.S. Cl. CPC H01M 8/0258; H01M 8/04067

(57) ABSTRACT

A bipolar plate and a fuel cell module using the same are provided. The bipolar plate includes a plate body and a temperature management component. The plate body has a plurality of reactive gas channels located on two opposite surfaces of the plate body, and the material of the plate body has a first thermal conductivity. The temperature management component is embedded within the plate body, and the material of the temperature management component has a second thermal conductivity. The first thermal conductivity is smaller than the second thermal conductivity. The temperature management component includes a plurality of tubes and a plurality of connecting elements, and the tubes communicate with each other through the connecting elements.

This application claims the benefit of Taiwan application Serial No. 104102505, filed Jan. 26, 2015, the disclosure of which is incorporated by reference herein in its entirety.

### TECHNICAL FIELD

The disclosure relates in general to a bipolar plate and a fuel cell module using the same, and more particularly to a bipolar plate having a temperature management component and a fuel cell module using the same.

### BACKGROUND

Along with the continual advance and improvement in technology and the increase in global population, nowadays people's demand for energy also increases no matter in transportation, industrial development or daily life appliance such as electronic products. Over a long period of time, people heavily rely on petrochemical fuel and use it as a main source of energy. If the current trend continues, the crude oil having been over-exploited will face the crisis of depletion. In the environmental aspect, the overuse of petrochemical energy and the discharge of greenhouse gases, such as carbon dioxide (CO₂), ozone (O₃) and methane (CH₄), have caused global warming and climate changes. If alternative energy solutions are not provided to replace the conventional petrochemical fuel, the humanity will face severe crisis in the near future.

The fuel that a fuel cell requires is hydrogen and air/oxygen. The fuel cell directly converts the chemical energy into the electrical energy. In comparison to the conventional internal combustion engine, the fuel cell has higher efficiency in energy conversion, and the byproduct originated from power generation is pure water, which is harmless to the environment. Thus, in recent ten years, the fuel cell technology has become one of the solutions with great potential for alternative energy. The fuel cell has a wide range of application. The type of the fuel cell is determined according to wattage and volume requirement, and the application of the fuel cell ranges from 3 C electronic products to local power plants. The fuel cell indeed possesses certain niches in various fields of development. Let the development of the low-temperature proton exchange membrane fuel cell (LT-PEMFC) be taken for example. In terms of long duration operation, one of the biggest factors for the degeneration of the cell is cathode flooding. If the operating temperature of the PEMFC is increased to 160-180° C. from 80° C., water will be generated in the form of vapor, and the flooding problem will thus be resolved completely.

There are many advantages for increasing the operating temperature of the PEMFC. Since the operation of the fuel cell is itself an exothermic reaction, temperature management becomes a crucial issue. No matter the heat is generated during the startup or during the operating process, the stability of the fuel cell still relies on suitable temperature management.

### SUMMARY

The disclosure is directed to a bipolar plate and a fuel cell module using the same. In the embodiments, the temperature management component is embedded within the plate body of the bipolar plate, such that the reactive gas channels can be disposed on two opposite surfaces of the plate body, and fuels and oxidants can be introduced through both sides of each of the bipolar plates. As such, temperature management can be performed without wasting extra space, such that the volume of the fuel cell module applying the bipolar plate can be reduced by half to achieve cell miniaturization. Thus, the volume power density of the fuel cell module can be increased, and the application field of the fuel cell module can be expanded.

According to one embodiment, a bipolar plate is provided. The bipolar plate includes a plate body and a temperature management component. The plate body has a plurality of reactive gas channels located on two opposite surfaces of the plate body, and the material of the plate body has a first thermal conductivity. The temperature management component is embedded within the plate body, and the material of the temperature management component has a second thermal conductivity. The first thermal conductivity is smaller than the second thermal conductivity. The temperature management component includes a plurality of tubes and a plurality of connecting elements, and the tubes are connected to each other through the connecting elements.

According to another embodiment, a fuel cell module is provided. The fuel cell module includes a membrane electrode assembly (MEA) and two bipolar plates, wherein the MEA is disposed between two bipolar plates. Each of the bipolar plates includes a plate body and a temperature management component. The plate body has a plurality of reactive gas channels located on two opposite surfaces of the plate body, and the material of the plate body has a first thermal conductivity. The temperature management component is embedded within the plate body, and the material of the temperature management component has a second thermal conductivity. The first thermal conductivity is smaller than the second thermal conductivity. The temperature management component includes a plurality of tubes and a plurality of connecting elements, and the tubes are connected to each other through the connecting elements.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a cross-sectional view of a bipolar plate according to an embodiment of the present disclosure.

FIG. 2A is a 3D diagram of a bipolar plate according to an embodiment of the present disclosure.

FIG. 2B is a 3D diagram of a bipolar plate according to another embodiment of the present disclosure.

FIG. 3 is a 3D diagram of a bipolar plate according to an alternate embodiment of the present disclosure.

FIG. 4 is a 3D diagram of a bipolar plate according to another alternate embodiment of the present disclosure.

FIGS. 5A-5D are schematic diagrams of tubes and connecting elements according to an embodiment of the present disclosure.

FIG. 6 shows a comparison of the dissipation effect between the bipolar plate according to an embodiment of the present disclosure and a plate body of a comparative example.

FIG. 7 shows a simulation result of a fuel cell module of a comparative example.

FIG. 8 shows a simulation result of a fuel cell module according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

In the embodiments of the present disclosure, the temperature management component is embedded within the plate body of the bipolar plate, such that the reactive gas channels can be disposed on two opposite surfaces of the plate body, and fuels and oxidants can be introduced through both sides of each of the bipolar plates. As such, temperature management can be performed without wasting extra space, such that the volume of the fuel cell module applying the bipolar plate can be reduced by half to achieve cell miniaturization. Thus, the volume power density of the fuel cell module can be increased, and the application field of the fuel cell module can be expanded. A number of embodiments of the present disclosure are disclosed below with reference to accompanying drawings. Detailed structures and configuration disclosed in the embodiments are exemplary and explanatory only, not for limiting the scope of protection of the present disclosure. Any person ordinary skilled in the technology of the present invention can make necessary modifications or adjustments to the said structures and configuration according to actual needs.

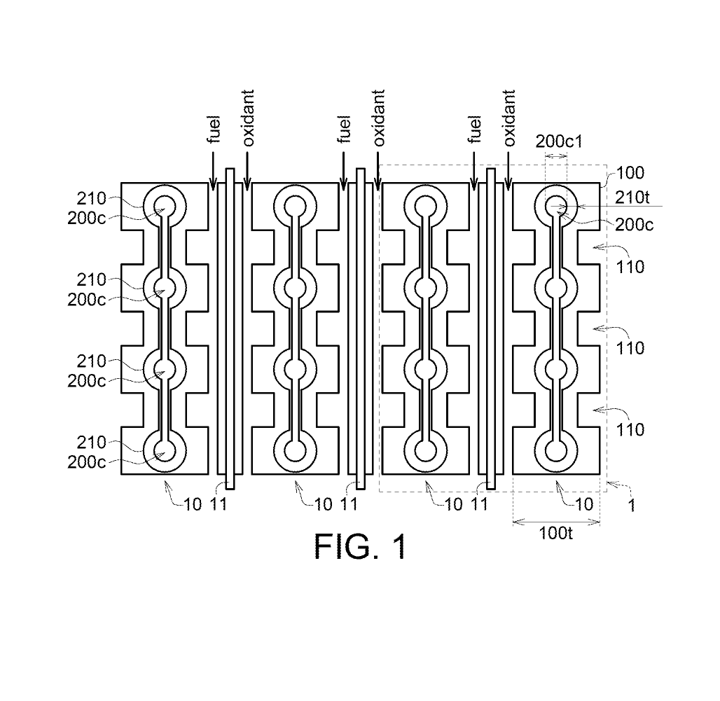

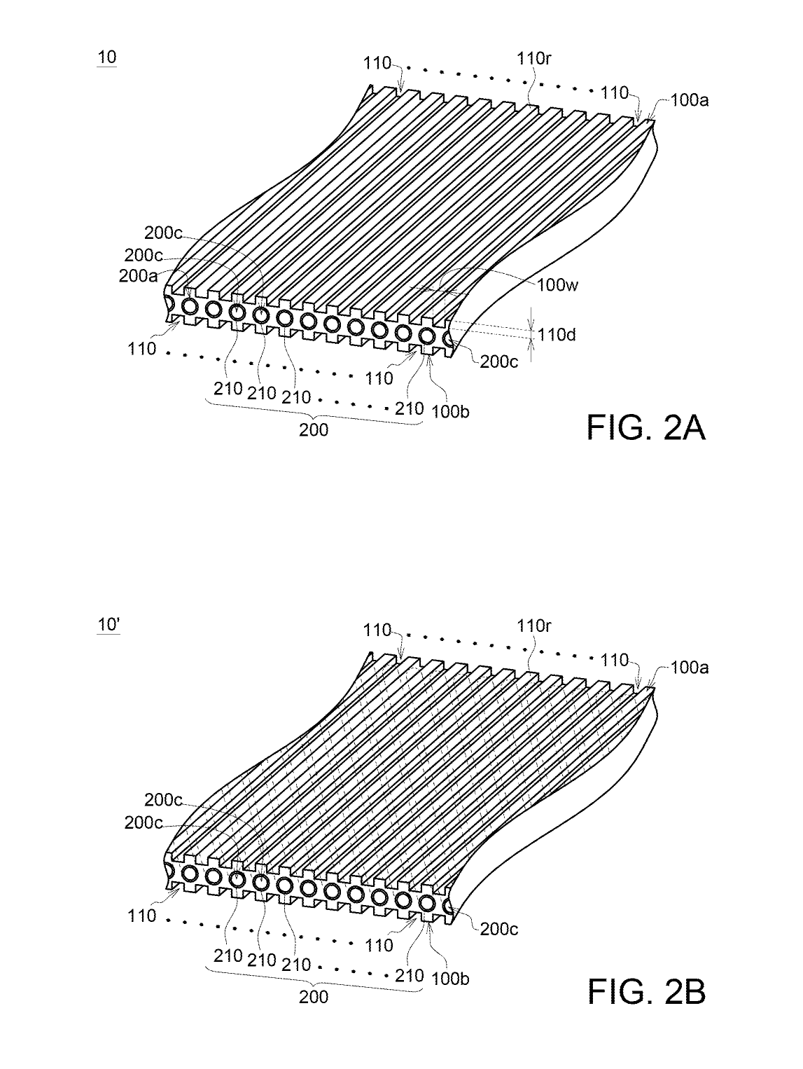

FIG. 1 is a cross-sectional view of a bipolar plate according to an embodiment of the present disclosure. FIG. 2A is a 3D diagram of a bipolar plate according to an embodiment of the present disclosure. As indicated in FIGS. 1-2A, the bipolar plate 10 includes a plate body 100 and a temperature management component 200. The plate body 100 has a plurality of reactive gas channels 110 located on two opposite surfaces 100a and 100b of the plate body 100. In other words, the two opposite surfaces 100a and 100b of the plate body 100 both have reactive gas channels 110. The temperature management component 200 is embedded within the plate body 100. The material of the plate body 100 has a first thermal conductivity, and the material of the temperature management component 200 has a second thermal conductivity. The first thermal conductivity is smaller than the second thermal conductivity. In an embodiment, the temperature management component may include a plurality of tubes 210 and a plurality of connecting elements, and the tubes 210 are connected to each other through the connecting elements.

According to an embodiment of the present disclosure, a fuel cell module is provided. As indicated in FIGS. 1-2A, the fuel cell module 1 includes a membrane electrode assembly (MEA) 11 and two bipolar plates 10, wherein the MEA 11 is disposed between the two bipolar plates 10. Descriptions of the bipolar plate 10 are disclosed above and are not repeated here. As indicated in FIGS. 1-2A, in an embodiment, the two opposite surfaces 100a and 100b of the plate body 100 of the bipolar plate 10 both have reactive gas channels 110, and the MEA 11 is disposed between every two adjacent bipolar plates 10. It should be noted that the embodiments of the bipolar plate disclosed below can all be applied in the fuel cell module of the embodiments of the present disclosure, and the descriptions of which are not repeated below.

In the embodiment, the reactive gas channels 110 allow a reactive gas to pass through. For example, fuel and oxidant can be introduced into the reactive gas channels 110, wherein the fuel is such as hydrogen (H₂), and the oxidant is such as oxygen (O₂). In the embodiment, the reactive gas channels 110 can be used for discharging water (H₂O) generated from the reaction. The plate body 100 has conductive property and is used for conducting the electricity generated by the MEA 11.

In a conventional PEMFC assembly, the reactive gas channels are disposed on only one surface of the bipolar plate, and the cooling channels are normally disposed on the other surface of the bipolar plate opposite to the reactive gas channels, that is, the junction between two bipolar plates, hence deteriorating the utilization of the bipolar plate. According to the embodiments of the present disclosure, the temperature management component 200 is embedded within the plate body 100 of the bipolar plate 10, the two opposite surfaces 100a and 100b of the plate body 100 both have reactive gas channels 110, such that fuels and oxidants can be introduced through both sides of the bipolar plate 10. Thus, when the bipolar plate is applied in the fuel cell module 1, given that the generation wattage remains unchanged, the volume of the fuel cell module 1 can be reduced by half to achieve cell miniaturization. Thus, the volume power density of the fuel cell module 1 can be increased, and the application field of the fuel cell module can be expanded.

Moreover, according to the embodiments of the present disclosure, the temperature management component 200 is embedded within the plate body 100 of the bipolar plate 10, and a plurality of tubes 210 are arranged as a plane. The planar arrangement of the tubes 210 basically corresponds to the shape of the bipolar plate 10, such that temperature can be more uniformly distributed inside the fuel cell module.

In an embodiment as indicated in FIGS. 1-2A, the temperature management component 200 has at least one fluid channel 200c. According to the embodiments of the present disclosure, the fluid channel 200c of the temperature management component 200 embedded within the plate body 100 may have an open channel structure or a closed channel structure, and different temperature management fluids can be infused to the fluid channel according to the operating state of the fuel cell module. For example, when the fuel cell module which uses the bipolar plate according to the embodiments of the present disclosure is in a startup stage, high-temperature fluid can be infused to the fluid channel 200c to heat the cell module to reach an operating temperature. When the fuel cell module is in an operating state, the cooling fluid can be infused to the fluid channel 200c to dissipate the heat generated during the operation of the fuel cell module, such that the heat can be recycled and the operating efficiency of the fuel cell module can be increased.

In the embodiment, the material of the plate body 100 has a first thermal conductivity of 10-50 W/m·K, and the material of the temperature management component 200 has a second thermal conductivity larger than or equal to 140 W/m·K.

In the embodiment, the material of the plate body 100 may include polymer mixed with conductive carbon. For example, conductive particles, such as particles of graphite, carbon black, carbon nanotubes, carbon spheres, and/or carbon fibers, can be mixed with the crystalline, semi-crystalline or amorphous polymer resin according to a suitable proportion. Then, the mixture is mixed and dispersed by a homogeneous mixing technology, such as the ball milling method, to form a mixed material, which is further used to form the plate body 100. During the mixing process, ceramic particles having chemical stability, such as the particles of silicon carbide, titanium carbide, or boron nitride, can be selectively added to the mixed material according to the characteristic requirement of the plate body 100.

In the embodiment, the material of the temperature management component 200 may include titanium, tin, tungsten, molybdenum, nickel steel alloy, stainless steel or any combination thereof.

The bipolar plate formed of conductive carbon having a graphite structure has the advantage of lower cost. However, tiny slits may easily occur to the bipolar plate formed of graphite due to the assembling or vibration of the bipolar plate, and the reactive gas may leak through the slits. According to the embodiments of the present disclosure, the temperature management component 200 having closed or open type fluid channels 200c is embedded with the carbon-based plate body 100 of the bipolar plate 10, such that the temperature management can be effectively and conveniently performed. Additionally, the metallic temperature management component 200 has a dense structure, not only increasing the volume power density but further effectively increasing the air-tightness of the bipolar plate 10.

Moreover, the metallic temperature management component 200 is embedded within the plate body 100 formed of polymer/conductive carbon to further increase the conducting property of the bipolar plate 10 and the mechanical strength of the entire structure.

In the embodiment, the temperature management component 200 directly contacts the plate body 100 by a rough outer surface 200a. In other words, the design of making the contact surface between the temperature management component 200 and the plate body 100 a rough surface increases the binding capacity between the temperature management component 200 and the plate body 100 and further increases the binding strength of heterogeneous materials between the temperature management component 200 and the plate body 100.

In the embodiment, the material of the plate body 100 has a first thermal expansion coefficient, the material of the temperature management component 200 has a second thermal expansion coefficient, and the difference between the first thermal expansion coefficient and the second thermal expansion coefficient can be smaller than or equal to 9.5 10⁻⁶/K. For example, the first thermal expansion coefficient is 0.5-6.5 10⁻⁶/K, and the second thermal expansion coefficient is 2-10 10⁻⁶/K. Through the matching of thermal expansion coefficients between the temperature management component 200 and the plate body 100, the stress generated from volume change caused by temperature change between the temperature management component 200 and the plate body 100 can be effectively reduced, and the binding strength of heterogeneous materials between the temperature management component 200 and the plate body 100 can be increased.

As indicated in FIGS. 1-2A, the reactive gas channels 110 are such as groove structures. Each groove has a depth 110d of 0.5-1.5 μm and a width 110w of 0.5-1.5 μm. The reactive gas channels 110 are separated from each other by such as 0.5-1.5 μm. As indicated in FIG. 2A, two adjacent reactive gas channels 110 are separated by a rib 110r having a width of 0.5-1.5 μm.

As indicated in FIGS. 1-2A, each tube 210 of the temperature management component 200 has a fluid channel 200c, and the tubes 210 are arranged in parallel.

In the present embodiment as indicated in FIGS. 1-2A, the extending direction of the tubes 210 is parallel to that of the reactive gas channels 110.

FIG. 2B is a 3D diagram of a bipolar plate 10′ according to another embodiment of the present disclosure. The tubes 210 embedded within the plate body 100 are illustrated in dotted lines. In the present embodiment as indicated in FIG. 2B, the tubes 210 and the reactive gas channels 110 of the plate body 100 are non-parallel to each other, that is, the extending direction of the tubes 210 is not parallel to that of the reactive gas channels 110. The extending direction of the tubes 210 and that of reactive gas channels 110 form an angle greater than 0° and smaller than 180°. For example, the extending direction of the tubes 210 can be perpendicular to that of reactive gas channels 110 (not illustrated). In another embodiment, the extending directions of the two reactive gas channels 110 located on two opposite surfaces 100a and 100b of the plate body 100 can be parallel or non-parallel to each other (not illustrated).

In an embodiment, the tube wall of the tube 210 has a thickness 210t of 0.5-1 μm, the fluid channel 200c has an inner diameter 200c1 of 1-2 μm, the plate body 100 has a thickness 100t about 3 μm, and the size of the fuel cell module 1 as indicated in FIG. 1 is about 6 μm. According to the conventional design, the cooling channel is disposed on the back side of the bipolar plate. According to the design as indicated in FIG. 1, both the two opposite surfaces 100a and 100b of the plate body 100 have reactive gas channels 110, and the fluid channel 200c of the temperature management component 200 is embedded within the plate body 100. Given that the generation wattage remains unchanged, the size of the fuel cell module 1 can be reduced by half and the volume power density will increase.

FIG. 3 is a 3D diagram of a bipolar plate according to an alternate embodiment of the present disclosure. For the elements common to the present embodiment and previous embodiment, the same designations are used to indicate identical or similar elements. Descriptions of relevant elements can be obtained with reference to above disclosure, and are not repeated here. It should be noted that the accompanying drawings are simplified such that the embodiments can be more clearly described, and dimension scales used in the accompanying drawings are not based on actual proportion of the product. Therefore, the specification and accompanying drawings are explanatory and exemplary only, not for limiting the scope of protection of the present disclosure. Particularly, the surface 100a of the plate body 100 is omitted in FIG. 3 to more clearly highlight the detailed structure of the temperature management component 200.

As indicated in FIG. 3, the tubes 210 of the temperature management component 200 of the bipolar plate 20 are connected to each other through the connecting elements 220. In the present embodiment as indicated in FIG. 3, every two adjacent tubes 210 can be connected through a connecting element 220. That is, two adjacent tubes 210 directly contact the same connecting element 220. In another embodiment, every two adjacent tubes 210 can be connected through more than one connecting elements 220 (not illustrated). That is, two adjacent tubes 210 directly contact the same group of connecting elements 220.

In the embodiment, each connecting elements 220 can be realized by a solid structure, and the fluid channels 200c of the tubes 210 are separated from each other. In the present embodiment, the fluids in different fluid channels 200c of the tubes 210 do not communicate with each other; that is, the fluids in different channels 200c is not interconnected. In another embodiment, each connecting element 220 can be realized by a hollowed channel structure, such that the fluid channels 200c of the tubes 210 can communicate with each other through the connecting elements 220; that is, the fluid channels 200c of the tubes 210 can be interconnected through the connecting elements 220. In the embodiment, the connecting elements 220 and the tubes 210 can be formed of the same material, and both have a thermal conduction efficiency superior to that of the plate body 100. According to the embodiments of the present disclosure, the tubes 210 are connected through the connecting elements 220 and are arranged as a plane, hence increasing the thermal conduction effect between the tubes 210 and making the overall thermal conduction of the temperature management component 200 more uniform.

Moreover, the whole planar structure formed from the tubes 210 and the connecting elements 220 further increases the airtightness of the bipolar plate, reduces the risk of the reactive gas located on two opposite surfaces of the plate body 100 infiltrating to the opposite surface, and avoids the exothermic reaction being too fast or even causing combustion, such that the stability of the overall device is increased.

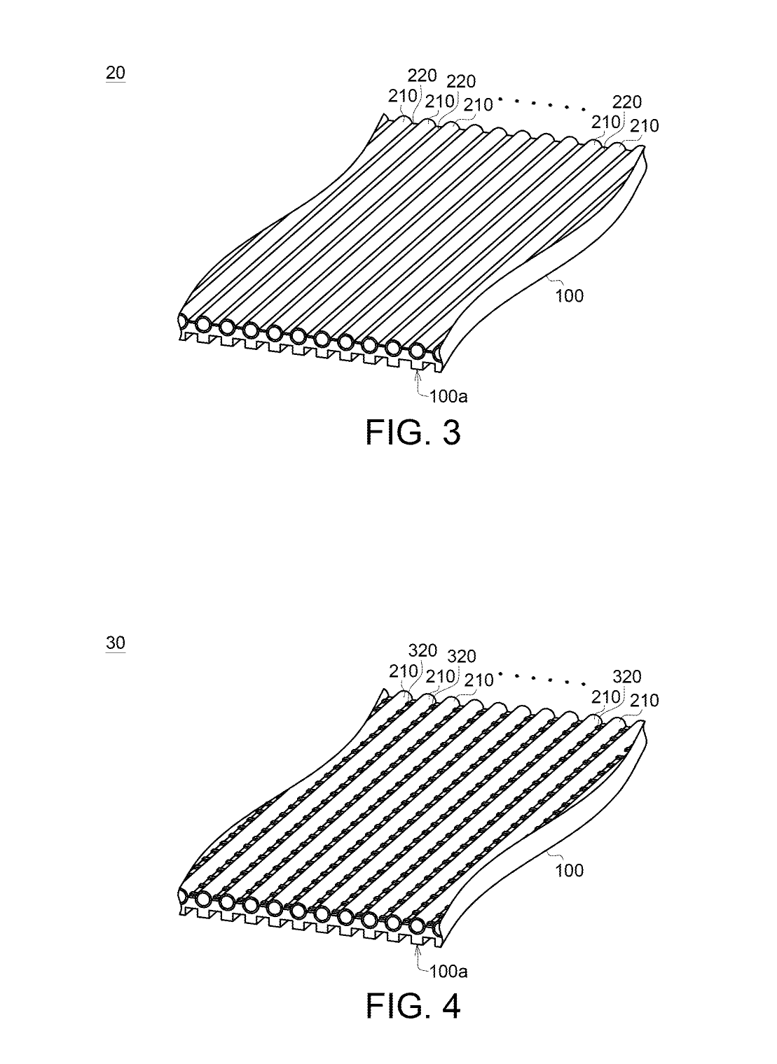

FIG. 4 is a 3D diagram of a bipolar plate according to another alternate embodiment of the present disclosure. For the elements common to the present embodiment and previous embodiment, the same designations are used to indicate identical or similar elements. Descriptions of identical similar elements can be obtained with reference to above disclosure, and are not repeated here. It should be noted that the accompanying drawings are simplified such that the embodiments can be more clearly described, and dimension scales used in the accompanying drawings are not based on actual proportion of the product. Therefore, the specification and accompanying drawings are explanatory and exemplary only, not for limiting the scope of protection of the present disclosure. Particularly, the surface 100a of the plate body 100 is omitted in FIG. 4 to more clearly highlight the detailed structure of the temperature management component 200.

As indicated in FIG. 4, in the temperature management component 200 of the bipolar plate 30, the tubes 210 communicate with each other through the connecting elements 320. In the present embodiment, the fluid channels 200c of the tubes 210 communicate with each other through the connecting elements 320. In another embodiment, each connecting element 320 can be realized by a solid structure, such that the fluids in different fluid channels 200c of the tubes 210 do not communicate with each other. In the present embodiment as indicated in FIG. 4, the fluid channels 200c of every two adjacent tubes 210 can communicate with each other through many connecting elements 320. That is, the fluids in the fluid channels 200c of two adjacent tubes 210 communicate with each other through many connecting elements 320. In another embodiment, the fluid channel 200c of every two adjacent tubes 210 can communicate with each other through only one connecting element 320 (not illustrated). That is, the fluids in the fluid channels 200c of two adjacent tubes 210 communicate with each other through a connecting element 320.

In the embodiment, each connecting element 320 can be realized by a hollowed channel, and the fluids in different fluid channels 200c of the tubes 210 communicate with each other through the connecting elements 320. When the fluids in different fluid channels 200c of the tubes 210 communicate with each other, the fluid can be uniformly distributed in the tubes 210, which are arranged as a plane, of the temperature management component 200. Thus, the temperature management component 200 has more uniform distribution of the heat and effectively avoids the structure of the device being negatively affected when the stress on different regions of the cell module varies due to non-uniform distribution of heat.

Moreover, the planar structure formed from the tubes 210 and the connecting elements 320 further increases the airtightness of the bipolar plate, reduces the risk of the reactive gas located on two opposite surfaces of the plate body 100 infiltrating to the opposite surface, and avoids the exothermic reaction being too fast or even causing combustion, such that the stability of the overall device is increased.

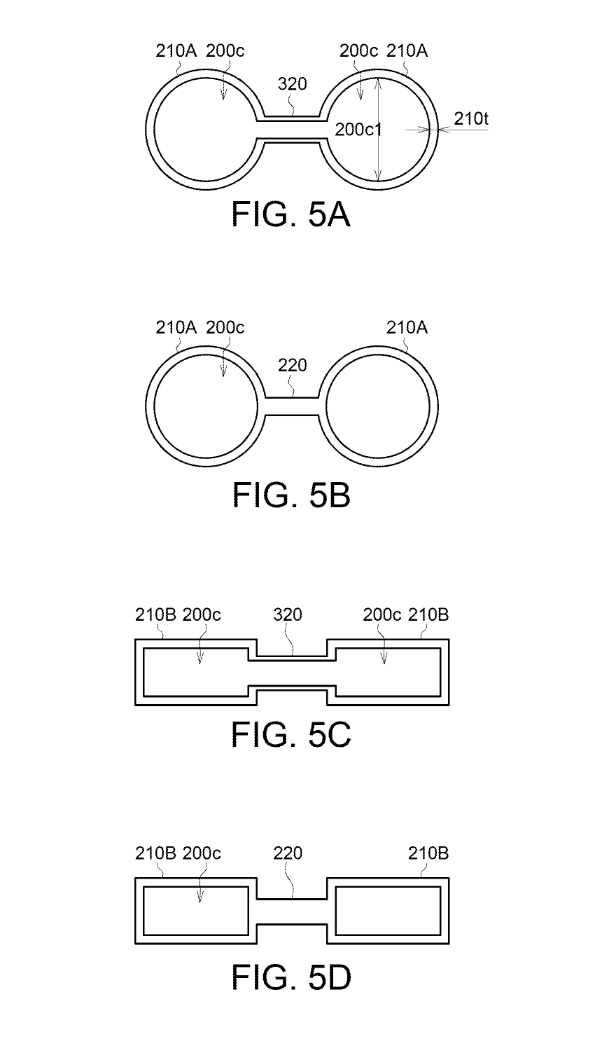

FIGS. 5A-5D are schematic diagrams of tubes and connecting elements according to an embodiment of the present disclosure. For the elements common to the present embodiment and previous embodiment, the same designations are used to indicate identical or similar elements. Descriptions of identical similar elements can be made with reference to above disclosure, and are not repeated here.

In some embodiments, the cross-section of the tube of the temperature management component 200 is in the shape of at least one of a circle, an oval, a polygon, and an irregular shape. In an embodiment, the cross-sections of all tubes of the temperature management component 200 can have the same shape. In another embodiment, the cross-sections of the tubes of the temperature management component 200 can have different shapes.

As indicated in FIG. 5A, the cross-section of each tube 210A is a circle, the fluid channels 200c of two adjacent tubes 210A communicate with each other through a connecting element 320. As indicated in FIG. 5B, the cross-section of each tube 210A is a circle, and two adjacent tubes 210A are connected to each other through a connecting element 220. As indicated in FIG. 5C, the cross-section of each tube 210B is a rectangle, and the fluid channels 200c of two adjacent tubes 210B communicate with each other through a connecting element 320. As indicated in FIG. 5D, the cross-section of the tube 210B is a rectangle, and two adjacent tubes 210B are connected to each other through a connecting element 220.

Let FIG. 5A be taken for example. In some embodiments, the tube wall of each tube has a thickness 210t of 0.5-1 μm, and the fluid channel has an inner diameter 200c1 of 1-2 μm.

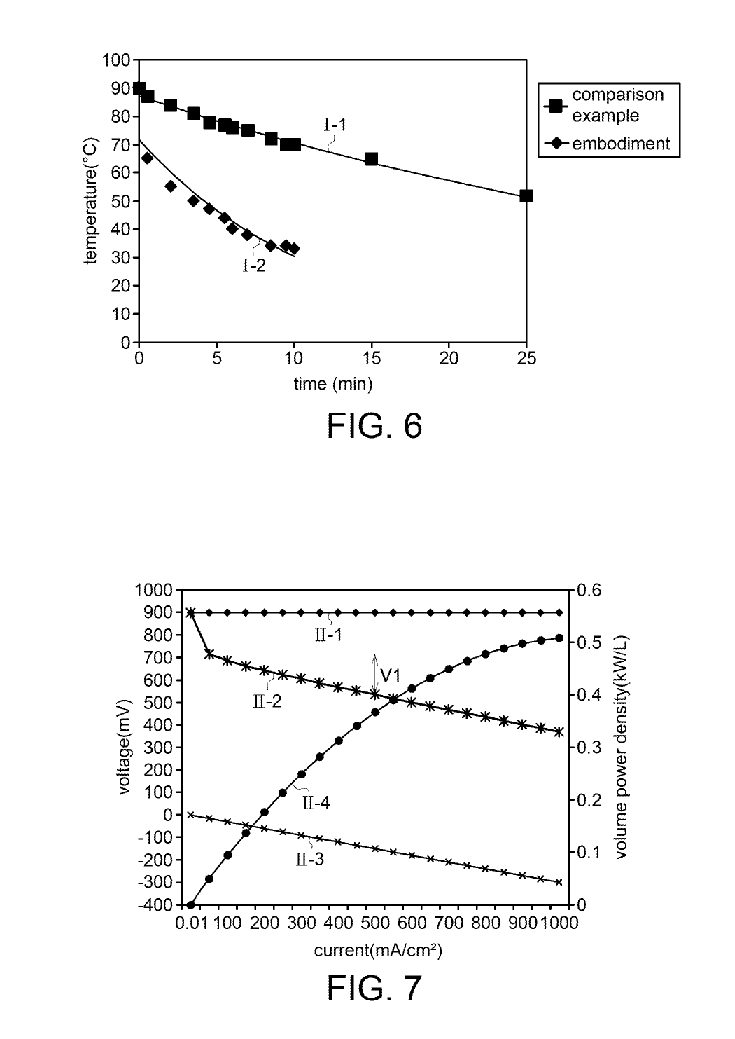

FIG. 6 shows a comparison of the dissipation effect between the bipolar plate according to an embodiment of the present disclosure and the plate body of a comparative example. The properties of the bipolar plate of the present disclosure and the fuel cell module using the same are described in a number of embodiments below. However, the embodiments disclosed below are exemplary and explanatory only, not for limiting the scope of protection of the present disclosure.

Embodiment vs comparative example: In the bipolar plate of an embodiment, the plate body is formed of a composite of conductive particles and polymers, and the tubes of the temperature management component are hollowed tubes formed of stainless steel and embedded within the plate body. In a comparative example, the plate body of the bipolar plate is formed of a composite of conductive particles and polymers without the embedded temperature management component.

Test method: Firstly, a bipolar plate of an embodiment of the present disclosure and a bipolar plate of a comparative example are respectively heated to a high temperature (90° C.). Then, cooling water is infused to the fluid channels of the tubes of the embedded temperature management component of the embodiment from an external source to cool the plate body, and at the same time, the plate body of the comparative example is cooled naturally. Then, a comparison is made between the cooling rate of the plate body of the bipolar plate of the embodiment and that of the comparative example.

As indicated in FIG. 6, curve I-1 represents the cooling curve of the comparative example, and curve I-2 represents the cooling curve of an embodiment of the present disclosure. Apparently, the plate body of the bipolar plate of the embodiment has embedded fluid channels, and the surface temperature quickly drops to about 60° C. within 30 seconds and then further drops to 30° C. within 10 minutes. Relatively, even after 25 minutes, the surface temperature of the plate body of the comparative example is still higher than 50° C. The comparison shows that the embedded fluid channels of the bipolar plate of the embodiment provide excellent dissipation effect.

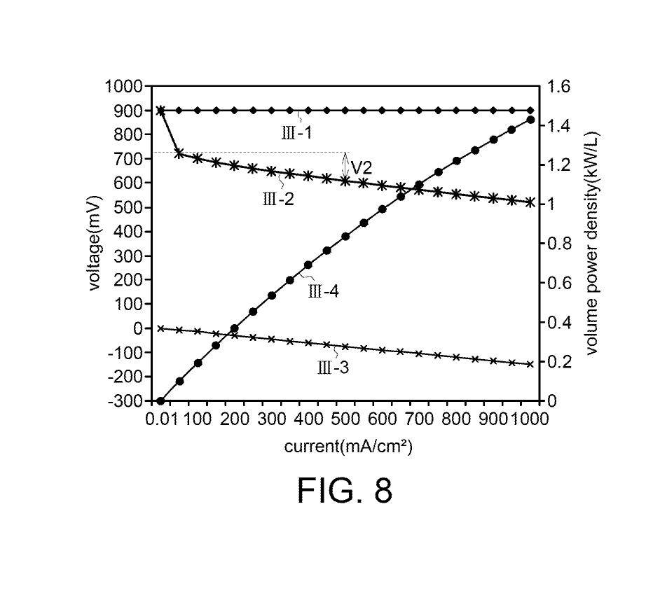

FIG. 7 shows a simulation result of a fuel cell module of a comparative example. FIG. 8 shows a simulation result of a fuel cell module according to an embodiment of the present disclosure. In the comparative example as indicated in FIG. 7, a conventional proton exchange membrane fuel cell is used for simulation, wherein only one surface of the bipolar plate has reactive gas channels, and the cooling channels are normally disposed on the other surface of the bipolar plate opposite to the reactive gas channels.

Referring to FIG. 7, curves II-1-II-4 are illustrated. Curve II-1 represents the current-voltage (I-V) curve of the fuel cell module of a comparative example obtained through simulation under ideal conditions. Curve II-2 represents the I-V curve of the fuel cell module of the comparative example obtained through simulation considering the factors of ohmic resistance of internal elements and the factor of catalyst efficiency. Curve II-3 represents the I-V curve of the fuel cell module of the comparative example obtained through simulation considering only the factor of ohmic resistance of internal elements. Curve II-4 represents the simulation result of the current-volume power density of the fuel cell module of the comparative example. As indicated in FIG. 7, due to the ohmic resistance, the output voltage drops as the current boosts, and the slope of curve II-2 is basically the same as that of curve II-3. This implies that no matter the factor of catalyst efficiency is considered or not, the ohmic resistance has about the same impact on the I-V curves of the fuel cell modules of the comparative examples.

As indicated in curve II-2 of FIG. 7, the voltage drop from 900 mV to 700 mV is caused by the factor of catalyst efficiency, and the voltage drop below 700 mV is caused by the factor of ohmic resistance. In terms of the voltage value at the current of 500 mA/cm², the voltage loss V1 caused by the factor of ohmic resistance is about 200 mV. After the current boosts to 950 mA/cm², the maximum volume power density is about 0.5 kW/L.

Referring to FIG. 8, curves III-1-III-4 are illustrated. Curve III-1 represents the I-V curve of the fuel cell module of an embodiment of the present disclosure obtained through simulation under ideal conditions. Curve III-2 represents the I-V curve of the fuel cell module of the embodiment obtained through simulation considering the factors of ohmic resistance of internal elements and the factor of catalyst efficiency. Curve III-3 represents the I-V curve of the fuel cell module of the embodiment obtained through simulation considering only the factor of ohmic resistance of internal elements. Curve III-4 represents the simulation result of the current-volume power density of the fuel cell module of the embodiment. As indicated in FIG. 8, due to the ohmic resistance, the output voltage drops as the current boosts, and the slope of curve III-2 is basically the same as that of curve III-3. This implies that no matter the factor of catalyst efficiency is considered or not, the ohmic resistance has about the same impact on the I-V curves of the fuel cell modules of the embodiments.

As indicated in curve III-2 of FIG. 8, the voltage drop from 900 mV to 700 mV is caused by the factor of catalyst efficiency, and the voltage drop below 700 mV is caused by the factor of ohmic resistance. In terms of the voltage value at the current of 500 mA/cm², the voltage loss V1 caused by the factor of ohmic resistance is about 100 mV. After the current boosts to 950 mA/cm², the maximum volume power density is about 1.4 kW/L.

Based on the results of FIGS. 7-8, in comparison to the fuel cell module of a comparative example, the fuel cell module of an embodiment of the present disclosure has a smaller ohmic resistance, and therefore has a smaller voltage loss and a larger volume power density.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A bipolar plate, comprising:
a plate body having a plurality of reactive gas channels located on two opposite surfaces of the plate body, wherein the material of the plate body has a first thermal conductivity; and
a temperature management component embedded within the plate body, wherein the material of the temperature management component has a second thermal conductivity;
wherein the first thermal conductivity is smaller than the second thermal conductivity, the temperature management component comprises a plurality of tubes and a plurality of connecting elements, and the tubes are connected to each other through the connecting elements.

2. The bipolar plate according to claim 1, wherein the tubes of the temperature management component and the reactive gas channels of the plate body are non-parallel to each other.

3. The bipolar plate according to claim 1, wherein the tubes of the temperature management component and the reactive gas channels of the plate body are parallel to each other.

4. The bipolar plate according to claim 1, wherein each of the tubes of the temperature management component has a fluid channel, and the tubes are arranged in parallel.

5. The bipolar plate according to claim 4, wherein the fluid channels of the tubes of the temperature management component communicate with each other through the connecting elements.

6. The bipolar plate according to claim 4, wherein the wall of each of the tubes has a thickness of 0.5-1 μm, and each of the fluid channels has an inner diameter of 1-2 μm.

7. The bipolar plate according to claim 1, wherein the cross-section of each of the tubes is in the shape of a circle, an oval, a polygon, or an irregular shape.

8. The bipolar plate according to claim 1, wherein the first thermal conductivity is 10-50 W/m·K, and the second thermal conductivity is greater than or equal to 140 W/m·K.

9. The bipolar plate according to claim 1, wherein the material of the temperature management component comprises titanium, tin, tungsten, molybdenum, nickel steel alloy, stainless steel or any combination thereof.

10. The bipolar plate according to claim 1, wherein each of the reactive gas channels is a groove having a depth of 0.5-1.5 μm and a width of 0. 5-1.5 μm, and the reactive gas channels are separated from each other by 0.5-1.5 μm.

11. The bipolar plate according to claim 1, wherein the temperature management component directly contacts the plate body by a rough outer surface.

12. The bipolar plate according to claim 1, wherein the material of the plate body has a first thermal expansion coefficient, the material of the temperature management component has a second thermal expansion coefficient, and the difference between the first thermal expansion coefficient and the second thermal expansion coefficient is smaller than or equal to 9.5 10⁻⁶/K.

13. A fuel cell module, comprising:
a membrane electrode assembly (MEA); and
two bipolar plates, wherein the MEA is disposed between the two bipolar plates, and each of the bipolar plates comprises:
a plate body having a plurality of reactive gas channels located on two opposite surfaces of the plate body, wherein the material of the plate body has a first thermal conductivity; and
a temperature management component embedded within the plate body, wherein the material of the temperature management component has a second thermal conductivity;
wherein the first thermal conductivity is smaller than the second thermal conductivity, and the temperature management component comprises a plurality of tubes and a plurality of connecting elements, and the tubes are connected to each other through the connecting elements.

14. The fuel cell module according to claim 13, wherein the tubes of the temperature management component and the reactive gas channels of the plate body are non-parallel to each other in each of the two bipolar plates.

15. The fuel cell module according to claim 13, wherein the tubes of the temperature management component and the reactive gas channels of the plate body are parallel to each other in each of the two bipolar plates.

16. The fuel cell module according to claim 13, wherein each of the tubes of the temperature management component has a fluid channel and the tubes are arranged in parallel in each of the two bipolar plates.

17. The fuel cell module according to claim 16, wherein the fluid channels of the tubes of the temperature management component communicate with each other through the connecting elements in each of the two bipolar plates.

18. The fuel cell module according to claim 16, wherein the wall of each of the tubes has a thickness of 0.5-1 μm, and each of the fluid channels has an inner diameter of 1-2 μm.

19. The fuel cell module according to claim 13, wherein the cross-section of each of the tubes is in the shape of a circle, an oval, a polygon, or an irregular shape.

20. The fuel cell module according to claim 13, wherein the first thermal conductivity is 10-50 W/m·K, and the second thermal conductivity is greater than or equal to 140 W/m·K.

21. The fuel cell module according to claim 13, wherein the material of the temperature management component comprises titanium, tin, tungsten, molybdenum, nickel steel alloy, stainless steel or any combination thereof in each of the two bipolar plates.

22. The fuel cell module according to claim 13, wherein each of the reactive gas channels is a groove having a depth of 0.5-1.5 μm and a width of 0.5-1.5 μm, and the reactive gas channels are separated from each other by 0.5-1.5 μm.

23. The fuel cell module according to claim 13, wherein the temperature management component directly contacts the plate body by a rough outer surface in each of the two bipolar plates.

24. The fuel cell module according to claim 13, wherein in each of the two bipolar plates, the material of the plate body has a first thermal expansion coefficient, the material of the temperature management component has a second thermal expansion coefficient, and the difference between the first thermal expansion coefficient and the second thermal expansion coefficient is smaller than or equal to 9.5 10⁻⁶/K.
